(19) United States
(12) Patent Application Publication
(10) Pub. No.: US 2012/0293340 A1
(43) Pub. Date: Nov. 22, 2012

(54) TRIGGERING RECHARGING AND WIRELESS TRANSMISSION OF REMOTE PATIENT MONITORING DEVICE

(76) Inventor: Eric K.Y. Chan, San Carlos, CA (US)

(21) Appl. No.: 13/475,133

(22) Filed: May 18, 2012

Related U.S. Application Data
(60) Provisional application No. 61/519,251, filed on May 19, 2011.

(51) Int. Cl. G08C 17/02

(52) U.S. Cl. 340/870.07

(57) ABSTRACT

Applicant has disclosed a convenient method of automatic identification, communication with, and battery life extension and automatic recharging for a medical telemetry device, worn by a patient. Applicant's preferred method in its broadest sense comprises: once a patient puts the medical telemetry device into or near a base unit for charging, the device automatically starts communicating physiological data via the Internet to clinicians and/or remote servers for analysis.

### RELATED APPLICATION

This application claims priority from Applicant's U.S. Provisional Patent Application, Ser. No. 61/519,251, filed May 19, 2011, for “TRIGGERING WIRELESS TRANSMISSION OF PHYSIOLOGICAL SIGNALS FOR REMOTE MONITORING.”Applicant claims the benefit of priority from that provisional application. Applicant also hereby incorporates the disclosure from that earlier application herein by reference.

### FIELD OF INVENTION

This invention relates generally to convenient physiologic monitoring devices worn by patients. More particularly, it relates to recharging such monitoring devices and transmitting their data with little patient effort.

### BACKGROUND OF THE INVENTION

Portable medical telemetry devices use battery power. Many are used by elderly patients who are ambulatory and either at home or institutionalized.

According to the U.S. Food and Drug Administration, wireless medical telemetry devices are generally used to monitor patient physiological parameters (e.g., cardiac signals) over a distance via radio-frequency (RF) communications between a transmitter worn by the patient and a central monitoring station. These devices have the advantage of allowing patient movement without tethering the patient to a bedside monitor with a hard-wired connection.

“Baby Boomers”—the group of individuals born between 1946 and 1964—represents the largest generation of Americans. As they enter the later stages of life and thereby become elderly, the use of such ambulatory medical telemetry devices will increase dramatically. Old age brings with it a lack of dexterity and poor eyesight coupled with difficulty managing technology and an increasing need for convenience. Therefore, there is a fast growing need for simple to use portable ambulatory medical monitoring devices that can operate over long periods of time with minimal user intervention.

Traditionally, replenishing the power supplies of telemetry devices has required physically replacing batteries at relatively high cost or connecting devices to a charging circuit by wire. Even without tools, battery replacement or connection to a power source taxes dexterity and eyesight. In addition, many types of recharging may interrupt the flow of data.

Accordingly, it is a primary object of the present invention to solve these problems by providing low power wireless on-demand remote recharging of medical telemetry devices coupled with battery saving features that prolong battery life and reduce the need for recharging.

It is another primary object to provide a method and apparatus, commensurate with the above-listed object, which not only recharges a patient's monitoring device but also triggers a wireless download of data for remote analysis.

It is another object to provide such a method and apparatus, which is easy for the patient to use.

### SUMMARY OF THE INVENTION

Applicant has disclosed a method which applies a plurality of different wireless modalities for detecting when an appropriately equipped patient-worn medical telemetry device is in range, prompting device wakeup, triggering data transmission, and initiating and performing recharging—either remotely by inductive means or in contact with a base unit by conduction, the method used depending in part on the relative proximity of the patient-worn device to the charger. The invention also: alerts the user when charging has been initiated or is needed; provides other alerts, and facilitates video monitoring and voice communication between patients and clinicians.

### BRIEF DESCRIPTION OF DRAWINGS

The above and other objects and advantages of the present invention will become more readily apparent upon reading the following description and reviewing the attached drawings in which:

FIG. 1 depicts a functional block diagrammatic overview of the invention;

FIG. 2 depicts a functional block diagram of the patient-worn device or “Patient Block”;

FIG. 3 depicts a functional block diagram of the system base station; and

FIG. 4 depicts an exemplary view of the relative placement of the Patient Block and base station.

### DETAILED DESCRIPTION OF THE PREFERRED EMBODIMENT(S)

Applicant has disclosed a method (and related apparatus) of providing wireless remote charging of portable, ambulatory, medical monitoring telemetry devices that includes device identification, handshaking, and communication with one or more wired base station units connected to a local or remote data analysis infrastructure. Applicant's method allows prompt device wakeup, triggering data transmission (an optional extra step), and initiating and performing recharging—either remotely by inductive means or in contact with a base unit by conduction, the method used depending in part on the relative proximity of the patient-worn device (“Patient Block”) to the charger. The patient-worn device contains the required means for asynchronous full and/or half-duplex communication with the base station in several modes and suitable receiving circuitry to generate electric current for an internal rechargeable battery.

Devices that could take advantage of the invention with appropriate modification include those described under U.S. Provisional Patent Application, Ser. No. 61/473,434, entitled “AMBULATORY PHYSIOLOGICAL MONITORING WITH REMOTE ANALYSIS”, filed Apr. 8, 2011 by Eric K. Y. Chan and Harold Strandquist (hereinafter “Chan et al.”). Mr. Chan is also the Applicant of the current application. That provisional application is hereby incorporated by reference.

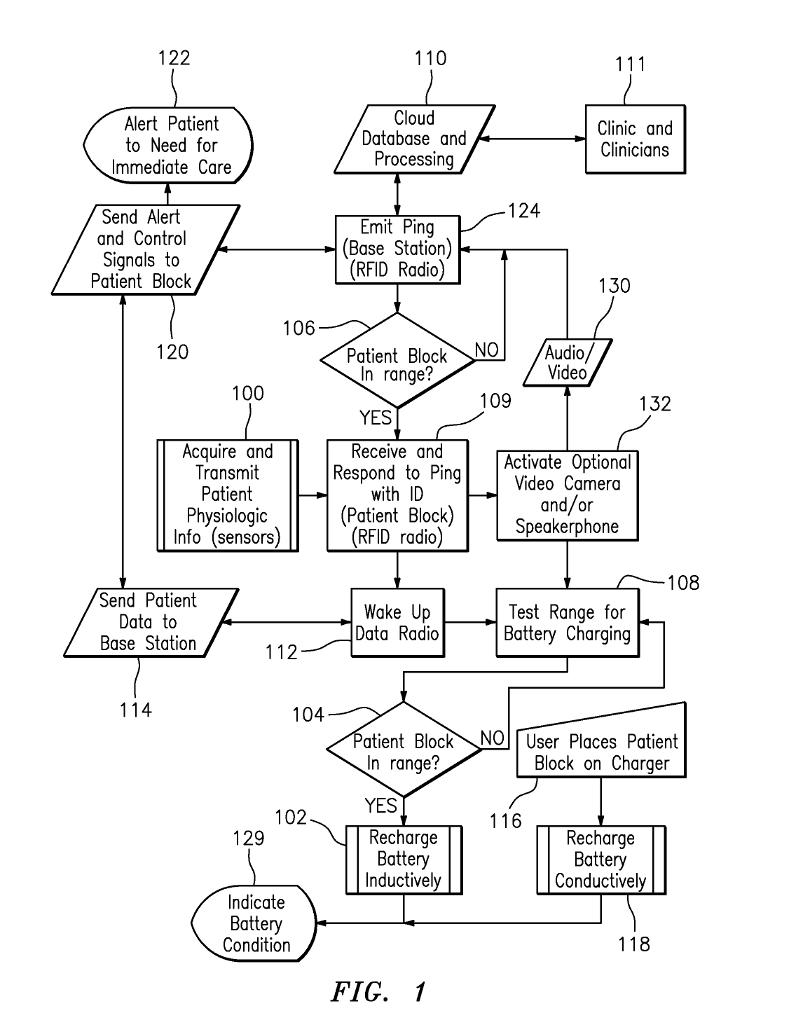

In the preferred “method” embodiment (see FIGS. 1-4), Applicant's method in its broadest sense comprises: charging a battery (block 102) of a patient-worn medical telemetry device, for acquisition of physiological data, by wireless induction from a base station (block 102), when the patient becomes within range (substantially 10 meters) (blocks 104, 106, 108) of the base station, even when the device is worn by the patient (e.g., while sleeping in bed). The preferred method can include the following extra steps: verifying identifying information from the device by RFID (block 109); and, upon verifying the information, triggering wireless transmission of physiological data from the medical telemetry device to a cloud-based remote server and to clinicians for analysis (blocks 110, 111). The types of information transferred are not of the type requiring constant monitoring.

Applicant's preferred method allows prompt device wakeup, triggering data transmission, and initiating and performing recharging—either remotely by induction (block 102) or in contact (block 116) with the base unit by conduction (block 118), the method used depending in part on the relative proximity of the patient-worn device to the charger. Transmission of patient physiologic data is not interrupted or otherwise affected by initiation of inductive charging.

Electricity can be generated by induction. That approach requires three basic elements: a conductor, a magnetic field, and relative motion between the conductor and the magnetic field. In the case of the present invention, relative motion is created by alternately expanding and contracting the magnetic field emitted by the base station around a metallic wire or foil conductor preferably arranged in the shape of a coil wherein the dimensions of the coil and the number of turns is optimized to generate the greatest amount of electricity over the greatest distance. The amount of electricity generated depends in part on the magnitude of the relative motion and the strength of the magnetic field; and, that strength diminishes rapidly with distance from the source.

Therefore, the highest charging rates (with Applicant's method) are obtained with the charge absorbing unit, i.e., the Patient Block, placed as near as possible and ideally in direct contact (block 118) with the base. However some charging is possible at greater distances and it is an object of this invention to provide charging when the Patient Block is not only in direct contact with the base station but also at distances of several feet away.

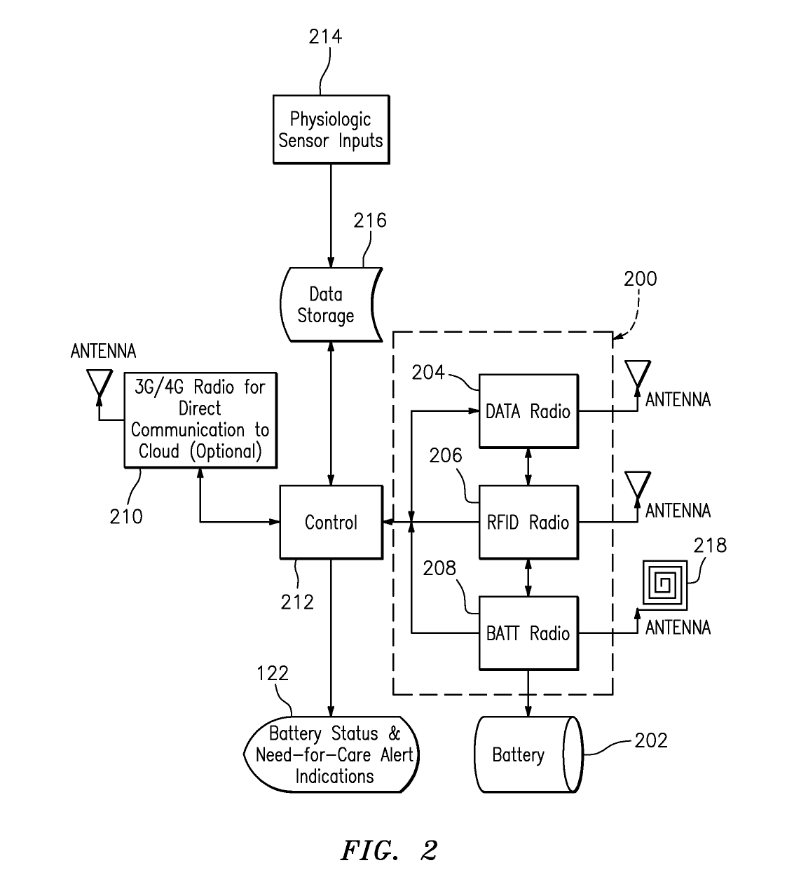

The patient-worn device contains the required means for asynchronous full and/or half-duplex communication with the base station in several modes and suitable receiving circuitry 200 (see FIG. 2) to generate electric current for an internal rechargeable battery (block 202).

As shown in FIG. 2, there are as many as three radio frequency circuits (blocks 204, 206, 208) present on the Patient Block. There is a RFID (Radio Frequency Identification) device (block 204) that absorbs radio frequency (“RF”) energy and then passively retransmits RF containing the Patient Block's unique identification number (“RFID radio”). There is a battery charging circuit (block 208) with a coil (218) as described earlier (“BATT radio”). And finally, there is a battery powered RF circuit (block 204) (“DATA radio”) used to communicate both patient data and also Patient Block status and alert information to and from the base station. The DATA radio (block 204) facilitates communication between the base station and the Patient Block using Bluetooth® or other sub 1 GHZ protocol (block 210). It is envisioned that a single radio could perform all the functions of the RFID, BATT, and DATA radios (204, 206, 208) however for ease of discussion; the radios are treated here as separate functional devices.

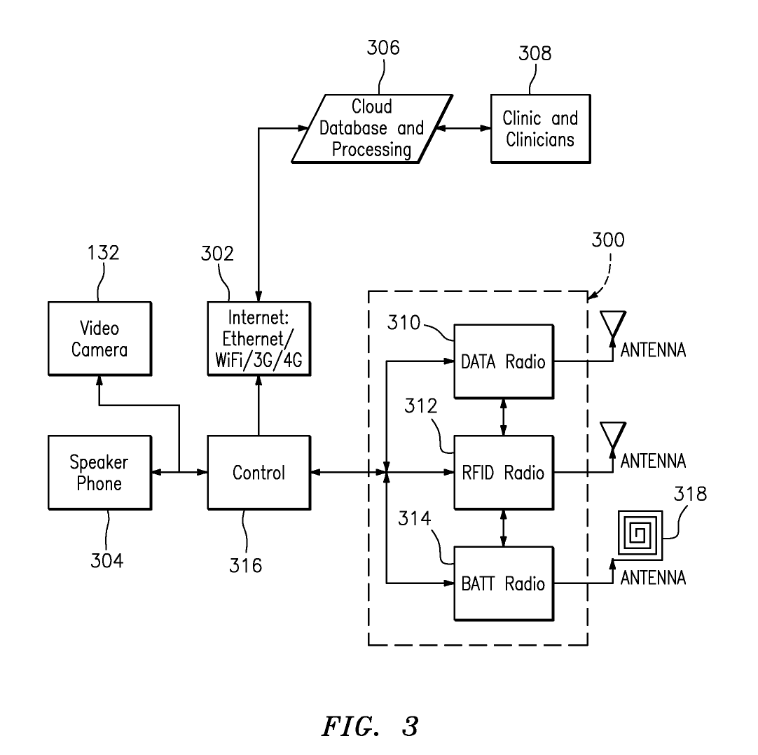

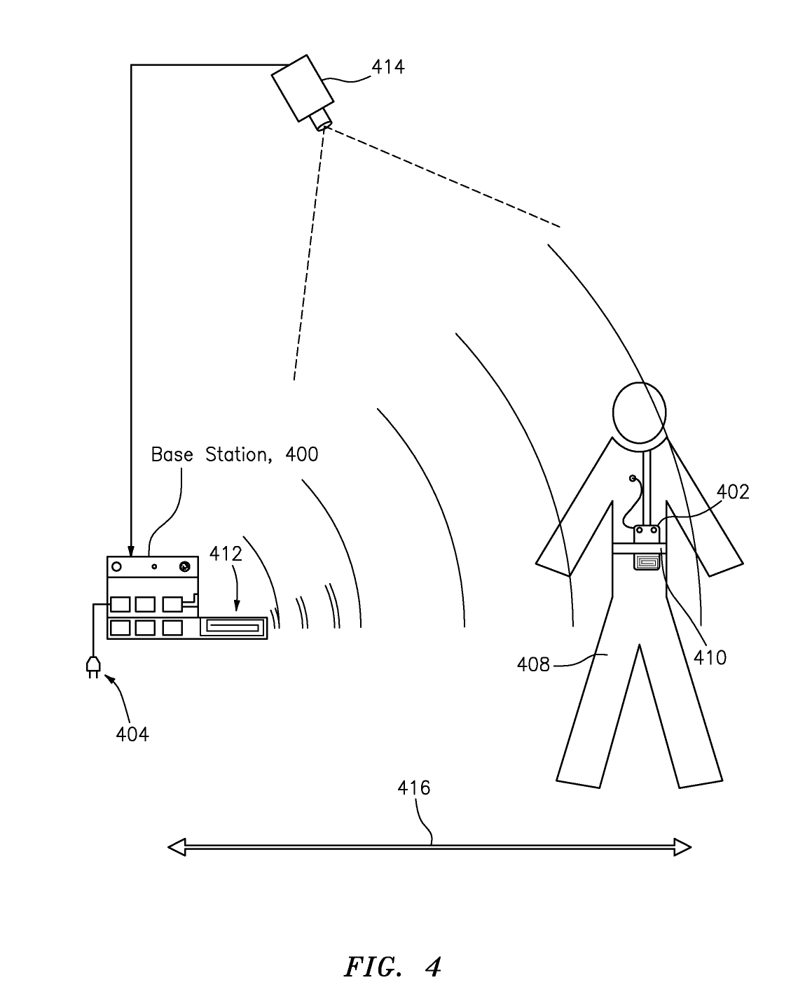

Referring to FIG. 4, the base station 400 is equipped with any suitable, complementary RF circuitry 300 (e.g. see FIG. 3) to emit and receive RFID pulses, to recharge the Patient Block battery, and to perform data communications with the Patient Block 402. The base station 400 is powered by AC power 404, and optionally has input connections for a video camera (not shown). FIG. 4 also depicts the Patient Block 402, attached to a patient 408 (e.g., by any suitable harness 410), and a contact charging station 412 in the base unit for docking the Patient Block for conductive charging, if desired. There is also an optional wide angle camera 414, operated by the base station 400. Double-arrowed line 416 indicates the RFID and DATA range from the base station.

The Patient Block preferably uses a Lithium Based (e.g., Lithium polymer) battery (block 202) that can be fully charged by the charging circuit in 3 to 45 minutes when left in close proximity to the base station (e.g., when the patient is showering). The Patient Block can be fitted with snaps, or Velcro®, or otherwise fastened and carried on a chest belt, waist belt or in a holster like a mobile phone. Wire leads attached to the patient provide physiological data for patient monitoring (block 214). At least one set of leads or one point of patient physical contact is required to provide minimum functionality, for example, a single lead electrocardiograph (“ECG”). The Patient Block can be capable of sensing an unspecified number of biological parameters including but not limited to patient oxygen saturation levels (SpO₂), blood pressure, temperature, high and low resolution ECG and more. The Patient Block 102 can be equipped with on-board data storage (block 216) and analysis software and can alert the patient to dangerous conditions requiring immediate medical attention (blocks 120, 122—FIG. 1).

In operation, the RFID reader (block 312) in the base station periodically emits a pulse or (“ping”) (block 124—FIG. 1). The RFID circuitry has two functions: it identifies the Patient Block to the base station; and it saves power on the Patient Block.

Referring to FIG. 3, the base station is connected to the Internet via an Ethernet connection, WiFi or possibly via 3G or 4G mobile phone technology (block 302). Communication with clinicians is via Skype° or other similar technology (block 304). Patient data can be transmitted wirelessly: to a remote server (block 306) that provides for data storage and rapid analysis and alert functions (blocks 120, 122—see FIG. 1); and/or to clinicians (block 308).

When the base radio is not communicating with the patient block using the DATA radio (block 310), the DATA radio (block 204) on the Patient Block is powered down by its controller (block 212—see FIG. 2) to save battery power. In response to a pulse from the base station RFID radio (block 312), if the Patient Block is within range (approximately within 10 meters), the RFID radio (block 206) in the Patient Block will reflexively transmit its unique SSID (“Service Set Identifier”) or IMEI (International Mobile Equipment Identity) ID number, and at the same time, “wake up” the higher powered DATA radio circuitry, energizing it (block 112). The DATA radio is preferably a CC430 “system on a chip” employing ZigBee° compliant protocol for up to 250 kbits/s and 400 m read distance, or alternatively, a proprietary protocol such as SimpliciTl network protocol combined with Texas Instruments' CC1101/2500 Sub 1 GHz network for up to 500 kbits/s and 2000 m read distance. Once the Patient Block DATA radio (block 204) is “awake”, the base station communicates with it and determines that the Patient Block is eligible and correctly paired with the base station and whether it is within range for charging (steps 104, 110, 112).

As discussed in “Scheduled Rendezvous and RFID Wakeup in Embedded Wireless Networks,” by Milan Nosovic and Terry Todd, Department of Electrical and Computer Engineering, McMaster University, Hamilton, Ontario, Canada, April, 2002, there are two modalities for RFID. In close coupled systems, the reader and transponder must have a maximum separation of 1 meter. The transponder need not be powered with a battery in close coupled systems because induced power is sufficient. Long range RFID typically requires a battery powered transponder. Long range RFID operates over distances of about 10 meters or more, in the 2.4 GHz to 24 GHz frequency range. Even when battery power is required, it typically requires three orders of magnitude less battery power than conventional radio communications. RFID on the Patient Block is implemented in the preferred embodiment using any suitable passive low power device, preferably Texas Instruments' TMS37157, which is compliant with ISO 18000-2. The TMS37157 model does not require a battery but is operable over a limited range.

The base station is connected to the Internet via Ethernet or other suitable modalities such as via phone modem, USB, WiFi or possibly Cellular telephone 302. The preferred Base Station RFID radio (block 312) is the Atmel° read/write base station U2207B, configured as shown on page 13 of “Atmel Read/Write Base Station U2207B”, Atmel Corporation (2006) (cited in Applicant's Information Disclosure Statement), which is hereby incorporated by reference. It should be noted that the specific radio models and manufacturers quoted herein are exemplary and any similar radio devices would work without changing the scope of the claims in this application.

Once the base station determines that the Patient Block is within range for charging (block 104—FIG. 1), the BATT radio in the base station (block 314) is energized developing the required resonant alternating magnetic field to enable generation of electricity within the coil of the Patient Block (block 318) and enabling charging of the Patient Block battery (block 202).

A controller (block 316) powers down the DATA Radio (block 310) of the base station when that DATA Radio is not being used.

In an alternate embodiment, the base station is equipped with any suitable charging pad (e.g., Duracell® “Drop and Go” charging system) (not shown) allowing the Patient Block to be placed in any orientation on that pad, in which case, the charging is conductive rather than inductive.

In addition to patient data transmission, the DATA Radio circuit (block 204) can carry Patient Block information such as battery status, and it can control Patient Block functions such as alerts (blocks 120, 122) and enabling of battery charge mode.

Applicant's preferred method can include the following steps:
a. preserving battery power on a patient-worn medical telemetry device by switching DATA radio power off (when unnecessary);
b. periodically transmitting an RFID pulse or “ping” from an AC powered base station;
c. receiving a ping on the RFID radio in the patient-worn medical telemetry device;
d. responding automatically to a ping by transmitting from an RFID radio identifying information from the patient-worn medical telemetry device;
e. awakening the DATA radio to enable communicating with a base station;
f. transmitting accumulated patient data to the base station from the patient-worn medical telemetry device;
g. communicating via the Internet to transmit patient data to a public cloud database software system;
h. determining whether the patient-worn medical telemetry device is within range for wireless inductive charging; and
i. initiating battery charging by wireless induction, when the medical telemetry device is within ten meters of the base station.

Additional steps can include: communicating alerts to the patient indicating the status of the medical telemetry device status or the patient's need of immediate medical attention. These alerts can include: facilitating voice communication between the patient and a remote clinic via the base station over the Internet; or facilitating video observation of the patient via a super wide angle video camera (blocks 130, 132) over the Internet.

It should be understood by those skilled in the art that obvious modifications can be made to Applicant's method or apparatus without departing from the spirit of the invention. For example, instead of or in conjunction with RFID, “Real-Time Location Systems” can be utilized (e.g., the Ekahau T301W Wearable Tag by Ekahau, Inc., which uses Wi-Fi; or the AwarePoint (RTLS) Sensor by Awarepoint Corporation, which uses ZigBee® technology). Accordingly, reference should be made primarily to the accompanying claims, rather than the foregoing description, to determine the scope of the invention.

I claim:

1. A method comprising:
a. inductively charging a battery of the medical telemetry device, while the device is worn by the patient, when the patient is within range of an AC powered base station;
b. verifying by RFID identifying information about a patient-worn medical telemetry device; and
c. upon verifying the information, triggering wireless transmission of patient data from the medical telemetry device for remote analysis.

2. The method of claim 1 wherein the patient information is transmitted by the base station.

3. A method comprising:
a. preserving battery power on a medical telemetry device, worn by a patient, by switching off power of a battery operated RF circuit;
b. periodically transmitting an RFID pulse from a base station;
c. receiving an RFID pulse on a RFID radio in the medical telemetry device;
d. responding automatically to the received RFID pulse by transmitting from the RFID radio identifying information from the medical telemetry device;
e. awakening the RF circuit in the medical telemetry device to enable communicating by the medical telemetry device with a base station;
f. upon the RF circuit awakening, transmitting physiological data of a patient from the medical telemetry device for remote analysis;
g. determining whether the medical telemetry device is within range for wireless inductive charging; and
h. initiating wireless inductive charging of a battery of the medical telemetry device when the medical telemetry device is within ten meters of the base station.

4. The method of claim 3 wherein the battery charging of the medical telemetry device takes place while the medical telemetry device is worn by the patient.

5. A method comprising:
a. transmitting a wireless signal from a powered base station;
b. receiving a wireless signal on an electrical circuit in the medical telemetry device;
c. responding automatically to the received signal by transmitting from the electrical circuit identifying information about the medical telemetry device;
d. awakening the electrical circuit to enable communicating by the medical telemetry device with the base station;
e. upon the electrical circuit awakening, transmitting physiological data of the patient from the medical telemetry device to the base station;
f. communicating via the Internet to transmit patient data for remote analysis;
g. determining whether the medical telemetry device is within range of the base station for wireless inductive charging; and
h. initiating wireless inductive charging of a battery of the medical telemetry device when the device is within range of the base station.

6. The method of claim 5 further comprising communicating alerts to the patient indicating a need for immediate medical attention.

7. The method of claim 6 further comprising facilitating voice communication between the patient and a remote clinic via the base station over the Internet.

8. The method of claim 7 further comprising facilitating video observation of the patient via a video camera over the Internet.

9. A method of identifying, triggering recharging, and triggering communicating with a medical telemetry device, worn by an ambulatory patient, comprising:
a. preserving battery power on the medical telemetry device by switching off power of a battery powered RF circuit in the medical telemetry device;
b. periodically transmitting a RFID pulse from a base station;
c. receiving a RFID pulse on a RFID device in the medical telemetry device;
d. responding automatically to the received pulse by transmitting from the RFID device identifying information about the medical telemetry device;
e. awakening the RF circuit to enable communicating with a base station;
f. transmitting patient data, from the medical telemetry device, via the Internet for remote analysis;
g. connecting the telemetry device to a battery charger of the base station;
and h. periodically recharging the medical telemetry device.

10. The method of claim 9 further comprising communicating alerts to the patient indicating a need of immediate medical attention.

11. The method of claim 9 further comprising facilitating voice communication between the patient and a remote clinic via the base station over the Internet.

12. The method of claim 9 further comprising facilitating video observation of the patient via a super wide angle video camera.
